(19) United States
(12) Patent Application Publication
(10) Pub. No.: US 2004/0085927 A1
(43) Pub. Date: May 6, 2004

(54) Message communication system and methodology

(75) Inventors: Ofer Yannay, Jerusalem (IL); Ofer Zelig, Petah Tikva (IL); Avi Kanon, Jerusalem (IL)

Correspondence Address: DARBY & DARBY P.C., 805 Third Avenue, New York, NY, 10022, US

(73) Assignee: GO4EAT LTD.

(21) Appl. No.: 10/378,515

(22) Filed: Mar. 3, 2003

Related U.S. Application Data
(60) Provisional application No. 60/424,108, filed on Nov. 5, 2002.

(51) Int. Cl. H04Q 7/00

(52) U.S. Cl. 370/329; 370/352

(57) ABSTRACT

A message communications system including a plurality of point-of-sale terminals including human sensible message receiving functionality and human sensible message delivering functionality and a communications network communicating with the plurality of point-of-sale terminals and transmitting thereto human sensible messages.

### REFERENCE TO CO-PENDING APPLICATION

Applicant hereby claims priority of U.S. Provisional Patent Application Serial No. 60/424,108, filed Nov. 5, 2002, entitled “ORDERS MANAGEMENT AND TRANSPORTING SYSTEMS”.

### REFERENCE TO COMPUTER PROGRAM LISTING APPENDIX

A computer program listing appendix is submitted herewith on one compact disc and one duplicate compact disc. The total number of compact discs including duplicates is two. The files on the compact disc are software object code and accompanying files for carrying out the preferred embodiment of the invention. Their names, dates of creation, directory locations, and sizes in bytes are:

ASPFILES.HEX of Feb. 3, 2003 located in the root folder and of length 59,531 bytes;

CARDCLIENT.HEX of Feb. 3, 2003 located in the root folder and of length 10,130,831 bytes;

DBBACKUP.HEX of Feb. 3, 2003 located in the root folder and of length 10,777,117 bytes;

TASKAGENTSTC.HEX of Feb. 3, 2003 located in the root folder and of length 78,706 bytes; and

GO4EATCC.HEX of Feb. 3, 2003 located in the root folder and of length 181,248 bytes.

The files are referred to herein as Appendix 1. The material on the compact discs is incorporated by reference herein.

### FIELD OF THE INVENTION

The present invention relates to message communication generally and more particularly to systems and methodologies for human sensible message communication.

### BACKGROUND OF THE INVENTION

The following U.S. Patents are believed to represent the current state of the art:

U.S. Pat. Nos. 6,473,739; 6,435,406; 6,425,524 and 5,969,968.

### SUMMARY OF THE INVENTION

The present invention seeks to provide systems and methodologies for human sensible message communication.

There is thus provided in accordance with a preferred embodiment of the present invention a message communications system including a plurality of point-of-sale terminals including human sensible message receiving functionality and human sensible message delivering functionality and a communications network communicating with the plurality of point-of-sale terminals and transmitting thereto human sensible messages.

In accordance with another preferred embodiment of the present invention, the plurality of point-of-sale terminals each include a dedicated point-of-sale communications processor operating software embodying the human sensible message receiving functionality and the human sensible message delivering functionality. Additionally or alternatively, the plurality of point-of-sale terminals each include dedicated point-of-sale software operating in cooperation with software embodying the human sensible message receiving functionality and the human sensible message delivering functionality.

There is also provided in accordance with another preferred embodiment of the present invention a message communications system including a plurality of terminals including human sensible message receiving functionality and human sensible message delivering functionality and a communications network communicating with the plurality of terminals and transmitting thereto human sensible messages, at least one of the plurality of terminals and the communications network having a mandatory human actuated acknowledgement functionality operative to prevent human sensible message delivery prior to provision of a human actuated acknowledgement; of receipt of the human sensible message.

In accordance with another preferred embodiment of the present invention the human sensible message receiving functionality includes text message receiving functionality, the human sensible message delivering functionality includes text message delivering functionality, the human sensible messages include- text messages and the communications network has a compression functionality operative to code the text messages, and employing a base 70 Latin character alphanumeric code of the type used in SMS messages. Additionally or alternatively, the human sensible message receiving functionality includes text message receiving functionality, the human sensible message delivering functionality includes text message delivering functionality, the human sensible messages include text messages and the communications network has a language conversion functionality operative to convert text messages in non-Latin letters to a base 70 Latin character alphanumeric code of the type used in SMS messages.

There is further provided in accordance with still another preferred embodiment of the present invention a message communications system including a plurality of terminals including text message receiving functionality and text message delivering functionality and a communications network communicating with the plurality of terminals and transmitting thereto text messages, the communications network having a compression functionality operative to code the text messages, and employing a base 70 Latin character alphanumeric code of the type used in SMS messages.

There is even further provided in accordance with yet another preferred embodiment of the present invention a message communications system including a plurality of terminals including text message receiving functionality and text message delivering functionality and a communications network communicating with the plurality of terminals and transmitting thereto text messages, the communications network having a language conversion functionality operative to convert text messages in non-Latin letters to a base 70 Latin character alphanumeric code of the type used in SMS messages.

In accordance with another preferred embodiment of the present invention, the human sensible message is received via an SMS message. Alternatively, the human sensible message is received via a data stream. Preferably, the data stream is a multiple protocol compatible data stream. Alternatively, the data stream is a multiple protocol compatible data packet. In accordance with yet another preferred embodiment of the present invention, the human sensible message is received via a data packet.

Preferably, the human sensible message contains a commercial order.

In accordance with a preferred embodiment of the present invention, the communications network includes a telephone network. Additionally, the telephone network includes an IVR, which receives a DTMF input and provides a voice response. Additionally or alternatively, the communications network includes a computer communications network. Alternatively or additionally, the communications network includes an at least partially Internet based computer communications network.

In accordance with another preferred embodiment of the present invention at least one of the plurality of terminals and the communications network have a mandatory human actuated acknowledgement functionality operative to prevent human sensible message delivery prior to provision of a human actuated acknowledgement of receipt of the human sensible message.

Preferably, the plurality of terminals include e-mail receiving functionality and mandatory human actuated acknowledgement functionality operative to prevent printing or display of a received e-mail prior to human actuated acknowledgement of receipt thereof. Alternatively or additionally, the plurality of terminals includes facsimile receiving functionality and mandatory human actuated acknowledgement functionality operative to prevent printing of a received facsimile prior to human actuated acknowledgement of receipt thereof Additionally or alternatively, the plurality of terminals includes file transfer receiving functionality and mandatory human actuated acknowledgement functionality operative to prevent opening, printing, saving or display of a received file prior to human actuated acknowledgement of receipt thereof

In accordance with another preferred embodiment, the mandatory human actuated acknowledgement functionality includes human acknowledger identification functionality, which identifies a human actuating the acknowledgement.

Preferably, the compression functionality is operative; to code a predetermined finite vocabulary.

In accordance with another preferred embodiment of the present invention the text message receiving functionality includes an SMS functionality.

There is also provided in accordance with another preferred embodiment of the present invention a message communication method including providing a communications network and a plurality of point-of-sale terminals including human sensible message receiving functionality and human sensible message delivering functionality, communicating between the communications network and the plurality of point-of-sale terminals and transmitting human sensible messages to the plurality of point-of-sale terminals.

In accordance with another preferred embodiment of the present invention the method also includes operating dedicated point-of-sale software in cooperation with software embodying the human sensible message receiving functionality and the human sensible message delivering functionality.

There is further provided in accordance with yet another preferred embodiment of the present invention a message communications method including providing a communications network and a plurality of terminals including human sensible message receiving functionality and human sensible message delivering functionality, communicating between the communications network and the plurality of terminals, transmitting human sensible messages to the plurality of terminals, acknowledging, via a mandatory human actuated acknowledgement functionality, receipt of the human sensible message, preventing delivery of the human sensible message until completion of the acknowledging and delivering the human sensible message, subsequent to the acknowledging.

There is yet further provided in accordance with still another preferred embodiment of the present invention a message communications method including providing a communications network and a plurality of terminals including text message receiving functionality and text message delivering functionality, communicating between the communications network and the plurality of terminals, transmitting text messages to the plurality of terminals and compressing the text messages employing a base 70 Latin character alphanumeric code of the type used in SMS messages prior to the transmitting.

There is even further provided in accordance with another preferred embodiment of the present invention a message communications method including providing a communications network and a plurality of terminals including text message receiving functionality and text message delivering functionality, communicating between the communications network and the plurality of terminals; converting text messages in non-Latin letters to a base 70 Latin character alphanumeric code of the type used in SMS messages and subsequently transmitting the text messages to the plurality of terminals.

In accordance with another preferred embodiment of the present invention the message communications method also includes operating software embodying the human sensible message receiving functionality and the human sensible message delivering functionality.

Preferably, the message communications method also includes receiving the human sensible message via an SMS message. Alternatively or additionally, the message communications method also includes receiving the human sensible message via a data stream. Additionally, the receiving the human sensible message via the data stream includes receiving the human sensible message via a multiple protocol compatible data stream. Alternatively, the receiving the human sensible message via the data stream includes receiving the human sensible message via a multiple protocol compatible data packet. Additionally or alternatively, the message communications method also includes receiving the human sensible message via a data packet.

Preferably, the transmitting human sensible messages includes transmitting commercial orders.

In accordance with a preferred embodiment of the present invention the communications network includes a telephone network. Additionally, the message communications method also includes receiving a DTMF input and providing a voice response. Alternatively or additionally, the communications network includes a computer communications network. Additionally or alternatively, the communications network includes an at least partially Internet based computer communications network.

In accordance with another preferred embodiment of the present invention the message communications method also includes acknowledging, via a mandatory human actuated acknowledgement functionality, receipt of the human sensible message, preventing delivery of the human sensible message until completion of the acknowledging and delivering the human sensible message, subsequent to the acknowledging.

Preferably, the transmitting human sensible messages includes transmitting e-mail messages and the preventing delivery includes preventing printing or display of the e-mail messages. Additionally, the transmitting human sensible messages includes transmitting facsimile messages and the preventing delivery includes preventing printing of the facsimile messages. Additionally, the transmitting human sensible messages includes transmitting files and the preventing delivery includes preventing opening, printing, saving or display of the files.

Preferably, the acknowledging also includes identifying the human performing the acknowledging.

In accordance with another preferred embodiment of the present invention the transmitting human sensible messages includes transmitting text messages and the method also includes compressing the text messages employing a base 70 Latin character alphanumeric code of the type used in SMS messages prior to the transmitting.

Preferably, the compressing includes coding a predetermined finite vocabulary. Additionally, the text message receiving functionality includes an SMS functionality.

Preferably, the transmitting human sensible messages includes converting text messages in non-Latin letters to a base 70 Latin character alphanumeric code of the type used in SMS messages and subsequently transmitting the text messages to the plurality of terminals.

### BRIEF DESCRIPTION OF THE DRAWINGS AND APPENDIX

The present invention will be understood and appreciated more fully from the following detailed description, taken in conjunction with the drawings in which:

FIG. 1A is a simplified pictorial illustration of one preferred embodiment of the present invention employed in a food service environment;

FIG. 1B is a simplified pictorial illustration of another preferred embodiment of the present invention employed in a food service environment;

FIG. 1C is a simplified pictorial illustration of yet another preferred embodiment of the present invention employed in a sales and service environment;

FIG. 1D is a simplified pictorial illustration of still another preferred embodiment of the present invention employed in a service environment;

FIGS. 2A, 2B, 2C and 2D are generalized illustrations illustrating various process stages in the embodiment of FIG. 1A;

FIG. 3 is a simplified flow chart illustrating operation of the embodiments of FIGS. 1A-1D;

FIGS. 4A, 4B, 4C and 4D are simplified flow charts further illustrating the functionality described in FIG. 3; and

FIG. 5 is a simplified flow chart illustrating the general operation of the functionality employed in FIGS. 1A-1D.

### APPENDIX LIST

Appendix 1 is a computer listing which forms a preferred software embodiment of the present invention.

### DETAILED DESCRIPTION OF PREFERRED EMBODIMENTS

A portion of the disclosure of this patent document, which includes a CD-ROM appendix, contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

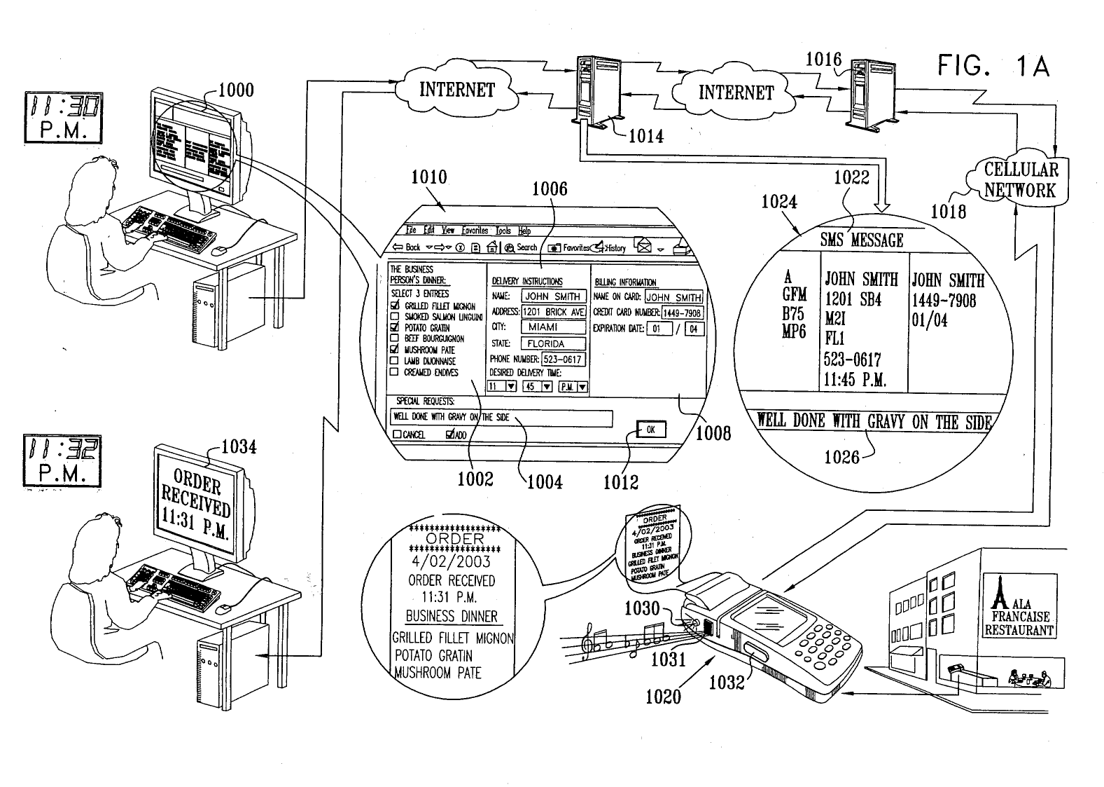

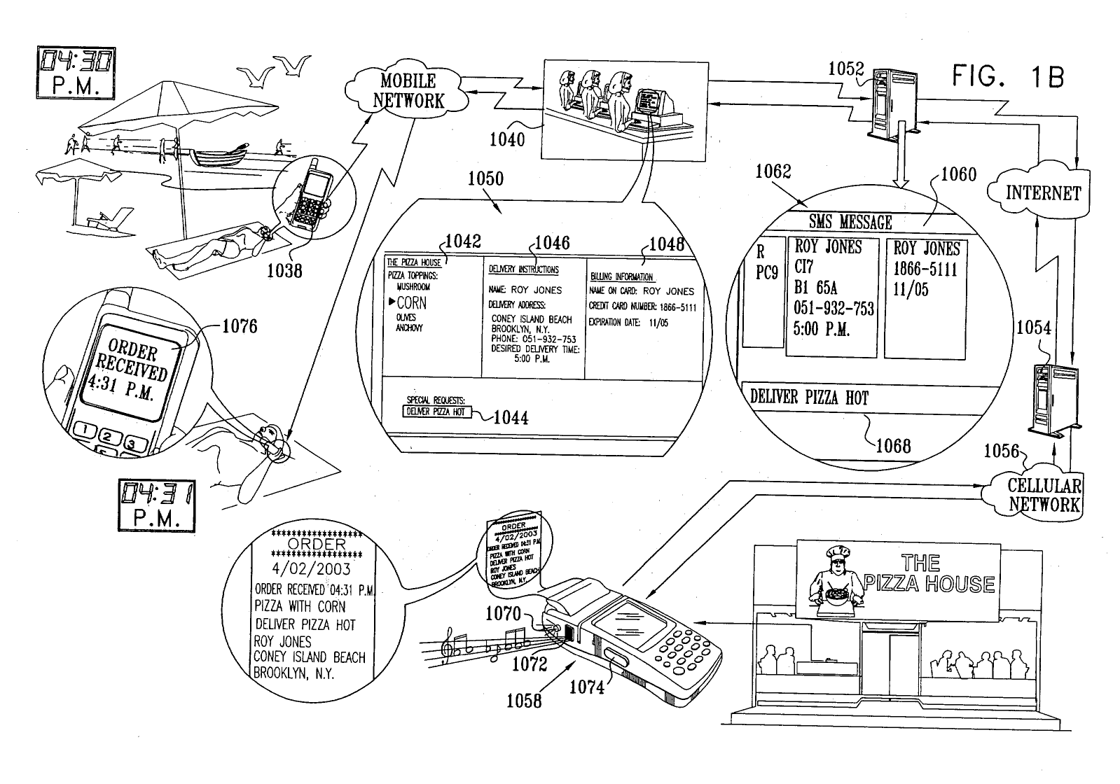

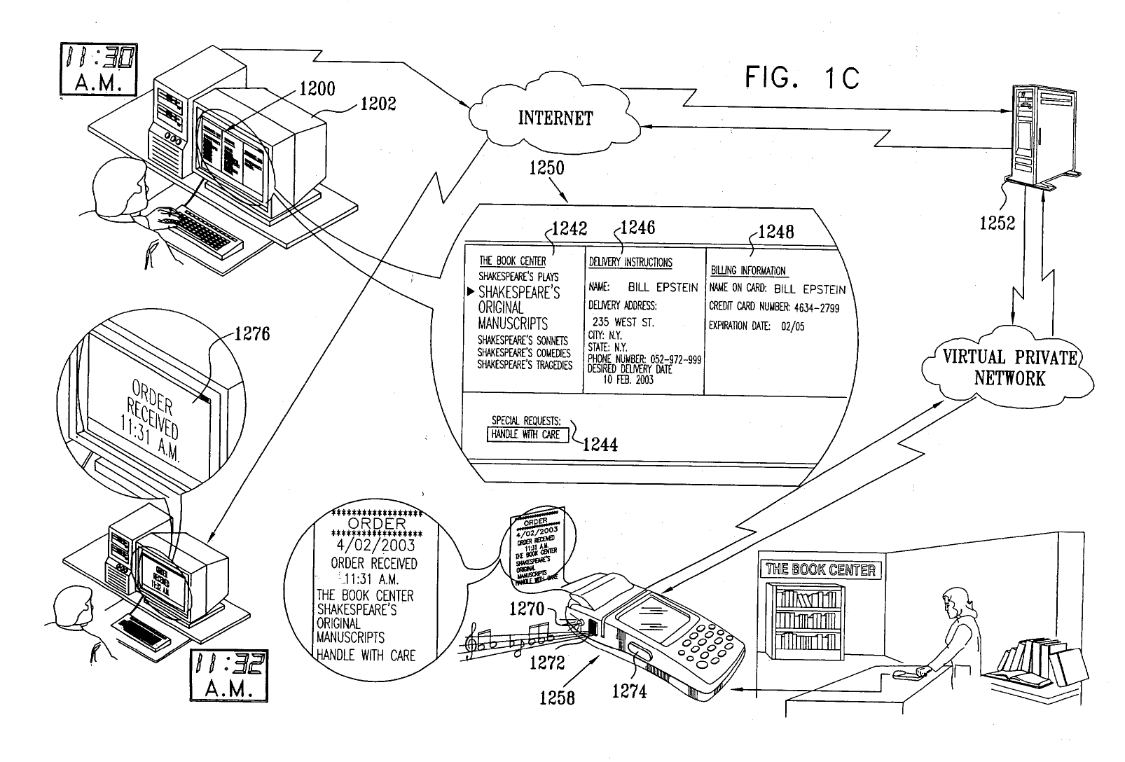

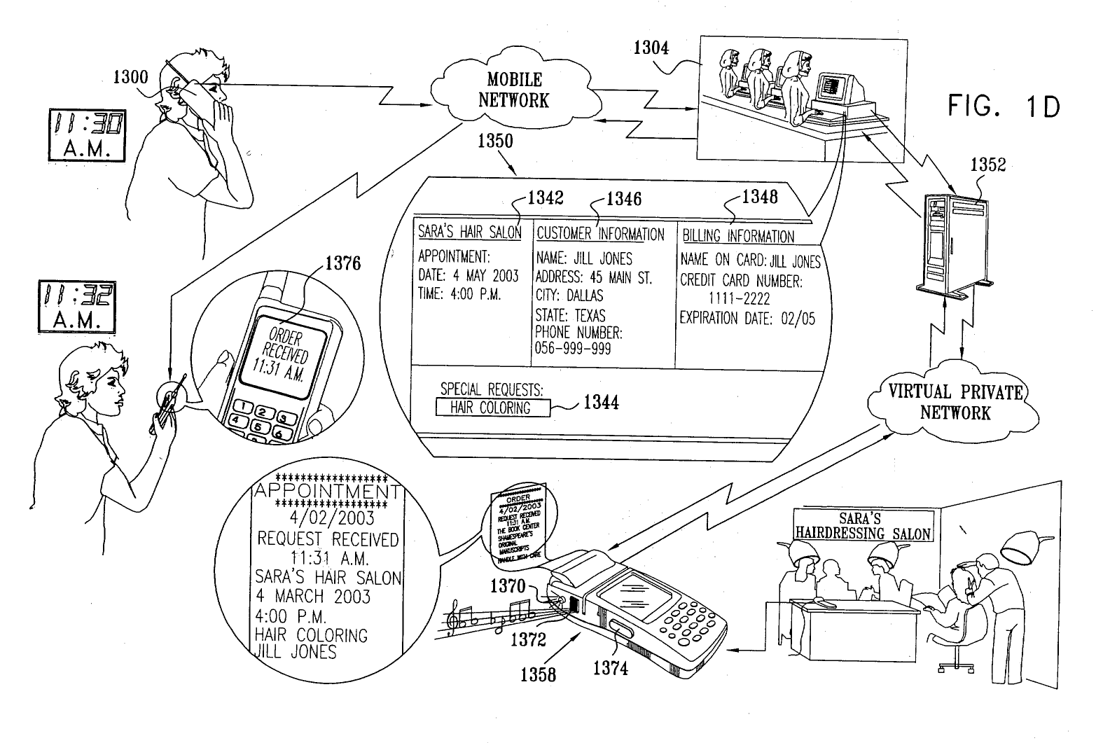

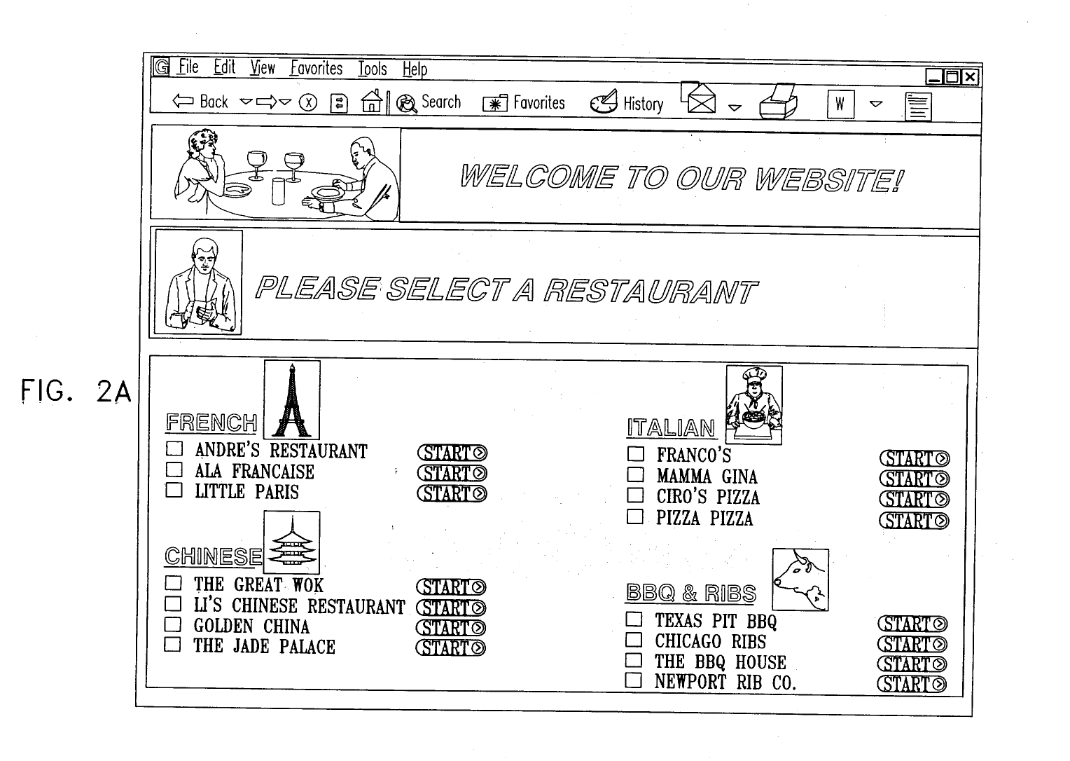

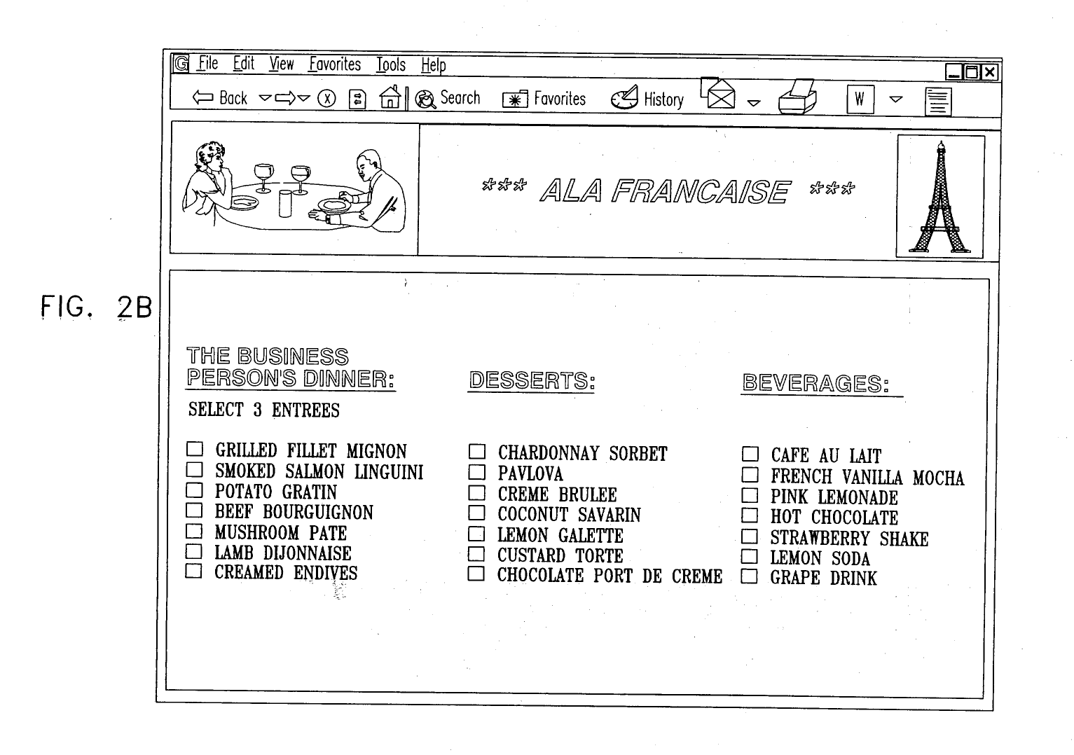

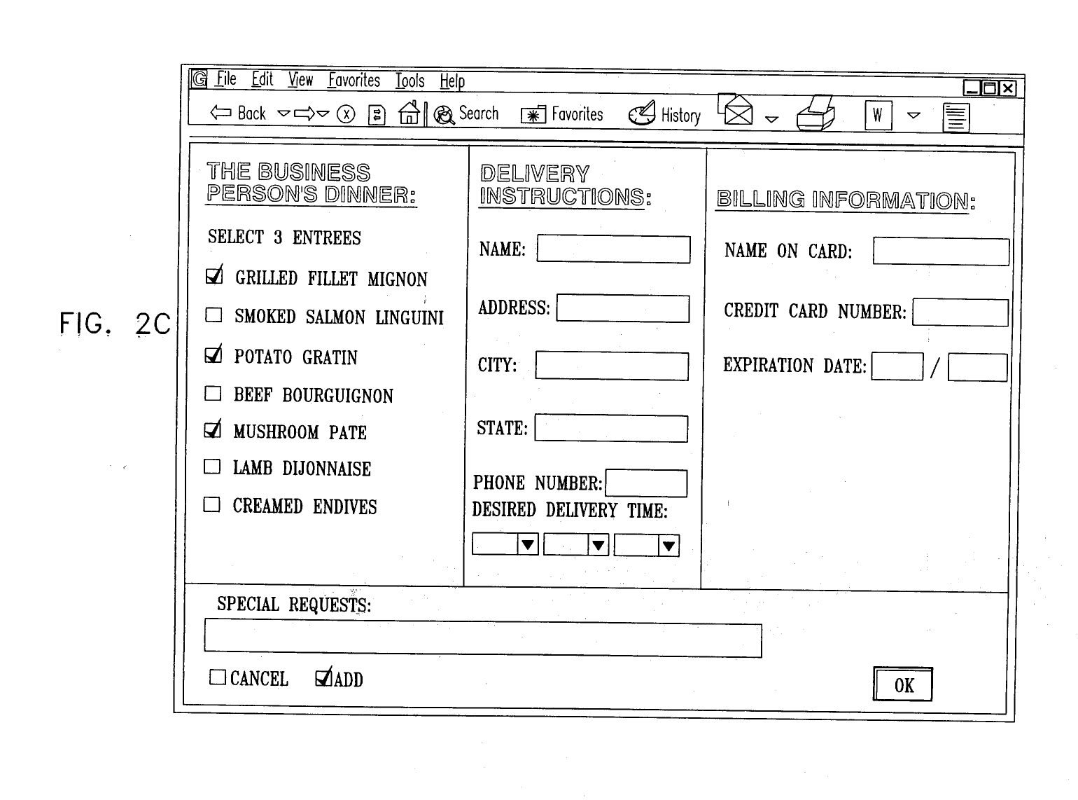

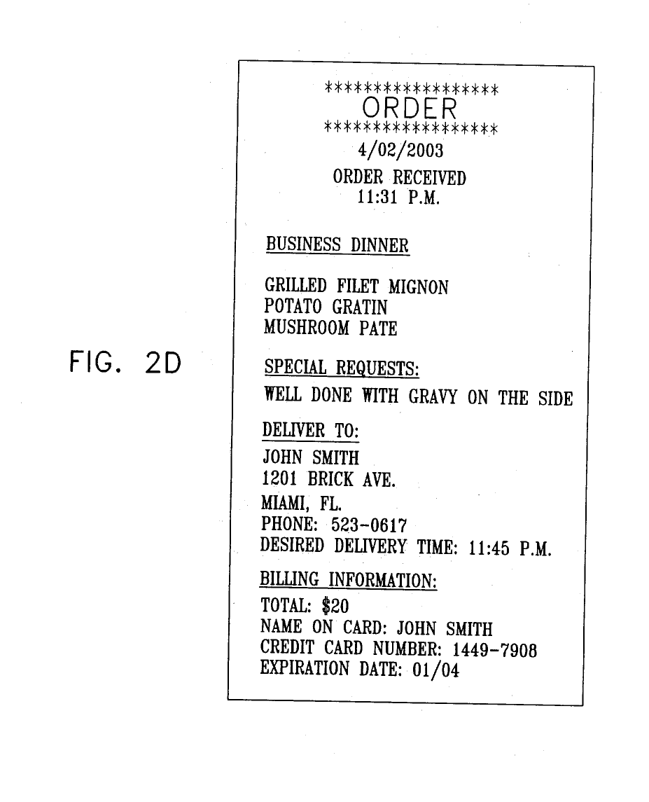

Reference is now made to FIG. 1A, which is a simplified pictorial illustration of one preferred embodiment of the present invention employed in a food service environment, and to FIGS. 2A, 2B, 2C and 2D, which are generalized illustrations illustrating various process stages in the embodiment of FIG. 1A. As seen in FIG. 1A, customers, such as engineers working late in an office, wish to order dinner without leaving their workplaces. In accordance with a preferred embodiment of the present invention the customers access a virtual restaurant site on the Internet from their desktop computers 1000. Typically, the home page of the site shows a multiplicity of take-out restaurants, here arranged by type of food, as shown in FIG. 2A.

A typical customer selects a restaurant and is then presented with a screen depicting the menu of that restaurant, as shown in FIG. 2B. The customer selects one or more menu items by clicking on appropriate buttons displayed on the screen, as shown in FIG. 2C. As seen in FIG. 2C, following the customer's selection of the menu items, the customer is invited to add special requests regarding the selected menu items, such as “WELL DONE”, “GRAVY ON THE SIDE”, delivery instructions, such as address, delivery time and telephone contact number, and transactional information, such as a credit card number. A typical order confirmation screen, including selected menu items 1002, special requests 1004, delivery instructions 1006 and transactional information 1008, is designated by reference numeral 1010. The customer clicks on an OK button 1012 on screen 1010 in order to affect the order.

A server 1014, on which the site is located, may be operative to store, based on previously entered information, a customer profile, typically including delivery instructions, such as a delivery address, and conventional transactional information, such as credit card information.

The server 1014 preferably processes the information relating to the customer's order and transmits it as a bit stream to an SMS server 1016, which interfaces with a mobile communication network 1018 and transmits information relating to the customer's order via the mobile network 1018 to a point-of-sale terminal 1020 located in a restaurant. The point-of-sale terminal 1020 is preferably a stand-alone point-of-sale terminal, such as an Elite 790 Model manufactured by Ingenico, located at 9 quai De Dion Bouton, 92816, Puteaux Cedex, France or a Nurit 3020 Model manufactured by Lipman Electronic Engineering Ltd. located at Park Afek Industrial Area, Rosh-Haayin, Israel, and may be located in a restaurant which may not have an Internet enabled computer. Servers 1014 and 1016 may be embodied in a single server.

It is a particular feature of the present invention that a point-of-sale terminal, and particularly a stand-alone point-of-sale terminal, is employed as an order receiving and confirming device.

It is also a particular feature of the present invention that upon receipt of the customer's restaurant and menu selections, typically via a conventional TCP/IP protocol using ASP and VB language, the server 1014 encodes the customer's menu item selections in a manner suitable for transmission, preferably in a compressed manner, in one or more SMS messages 1022, such as in a form designated by reference numeral 1024.

A preferred type of compression, which is particularly suitable for use in conventional SMS messaging, employs a base 70 Latin character alphanumeric code of the type conventional in SMS messages. In the illustrated embodiment, the SMS message appears as a series of numbers and letters, each of which represents a click selectable menu item.

In the illustrated embodiment, for example, the following coding is employed:

a=businessperson's dinner

gfm=grilled fillet mignon

s45=smoked salmon linguini

b75=potato gratin

91c=beef bourguignon

g8=lamb dijonnaise

mp6=mushroom pate

It is appreciated that the above-described compression technique is particularly applicable for use with menu items in foreign languages, particularly those reading right to left, such as Hebrew and Arabic, since it is language and reading direction independent and thus does not impose reading direction dependent overheads on information transmission bandwidth.

In accordance with a preferred embodiment of the present invention, the free-text space reserved for special requests 1004 is preferably transmitted without compression in the SMS message, as shown at reference numeral 1026.

When operating in a foreign language, specifically a language that uses non-Latin letters, a 1 to 1, letter to letter, encoding table is preferably employed, so as to enable the SMS message to be transmitted in Latin characters, thereby avoiding SMS overheads associated with non-Latin characters. The foreign language that uses non-Latin letters may be a language read from left to right, such as Russian, or a language read from right to left, such as Hebrew and Arabic.

A typical such table appears hereinbelow:

TABLE 1

| | | | | | | | |
|---|---|---|---|---|---|---|---|
| A | [symbol] | H | [symbol] | O | [symbol] | V | [symbol] |
| B | [symbol] | I | [symbol] | P | [symbol] | W | [symbol] |
| C | [symbol] | J | [symbol] | Q | [symbol] | X | [symbol] |
| D | [symbol] | K | [symbol] | R | [symbol] | Y | [symbol] |
| E | [symbol] | L | [symbol] | S | [symbol] | Z | [symbol] |
| F | [symbol] | M | [symbol] | T | [symbol] | a | [symbol] |
| G | [symbol] | N | [symbol] | U | [symbol] | | |

The SMS messages 1022 also preferably include the customer's delivery instructions and transactional information. This data may be encoded as described hereinabove, in whole or in part, sent in a free-text form, or transmitted in any other suitable manner. The customer's delivery instructions and transactional information may also be stored in the point-of-sale terminal 1020 or otherwise in a restaurant accessible manner, so as not to have to be transmitted with the order in an SMS message.

In accordance with a preferred embodiment of the invention, the point-of-sale terminal 1020 is operative to print out or otherwise display the contents of the SMS message 1022 in a human-readable form, as shown in FIG. 2D. Optionally, the transactional information may not be printed with the order and may be automatically processed in a paperless manner via the point-of-sale terminal 1020 or in any other suitable conventional manner.

In accordance with a preferred embodiment of the present invention, prior to printing out the contents of the SMS message 1022, a human sensible “order waiting” indication is actuated by the SMS message 1022, such as by illuminating a light 1030 on the point-of-sale terminal or providing an audio indication 1031. Only when a human operator presses an “order receipt acknowledged” button 1032, which may be a conventional “Enter” button or on another suitably designated menu location on the point-of-sale terminal 1020, is the print or display provided. This functionality ensures that a positive acknowledgement of order receipt is provided. This acknowledgement is preferably communicated via an SMS message to server 1014 and is further communicated, preferably via the TCP/IP Internet protocol from the server to the customer and is displayed on the computer screen, as designated by reference number 1034.

Reference is now made to FIG. 1B, which is a simplified pictorial illustration of another preferred embodiment of the present invention employed in a food service environment. As seen in FIG. 1B, customers, such as vacationers at the beach, wish to order dinner to be delivered to them at the beach.

In accordance with a preferred embodiment of the present invention, the vacationer employs a cellular telephone 1038 to place a telephone call via a mobile network to a call center 1040, such as a manned call center or an IVR computer-based call center. Following the customer's selection of the menu items, the customer is invited to add special requests regarding the selected menu items, such as “HOT”, delivery instructions, such as address, time and telephone contact number, and transactional information, such as a credit card number. A typical computer screen at the call center, including selected menu items 1042, special requests 1044, delivery instructions 1046 and transactional information 1048, is designated by reference numeral 1050.

The call center operator, human or computer, preferably accesses restaurant ordering software on a server 1052, which may be the same server as server 1014 in the embodiment of FIG. 1A.

Server 1052, in which the software may be installed, may be operative to store, based on previously entered information, a customer profile, typically including delivery instructions, such as a delivery address, and conventional transactional information, such as credit card information.

The server 1052 preferably processes the information relating to the customer's order and transmits it as a bit stream to an SMS server 1054, which interfaces with a mobile communication network 1056 that transmits information relating to the customer's order to a point-of-sale terminal 1058 located in a restaurant. The point-of-sale terminal is preferably a stand-alone point-of-sale terminal, such as an Elite 790 Model manufactured by Ingenico, located at 9 quai De Dion Bouton, 92816, Puteaux Cedex, France or a Nurit 3020 Model manufactured by Lipman Electronic Engineering Ltd. located at Park Afek Industrial Area, Rosh-Haayin, Israel, and may be located in a restaurant which may not have an Internet enabled computer. Servers 1052 and 1054 may be embodied in a single server.

It is a particular feature of the present invention that a point-of-sale terminal, and particularly a stand-alone point-of-sale terminal, is employed as an order receiving and confirming device.

It is also particular feature of the present invention that upon receipt of the customer's restaurant and menu selections, typically via a conventional TCP/IP protocol using ASP and VB language, the server 1052 encodes the customer's menu item selections in a manner suitable for transmission in one or more SMS messages 1060, preferably in a compressed manner, such as that designated by reference numeral 1062.

A preferred type of compression, which is particularly suitable for use in conventional SMS messaging, employs a base 70 Latin character alphanumeric code of the type conventional in SMS messages. In the illustrated embodiment, the SMS message appears as a series of numbers and letters, each of which represents a selectable menu item.

In the illustrated embodiment, for example, the following coding is employed:

r=the pizza house

pc9=pizza with corn

It is appreciated that the above-described compression technique is particularly applicable for use with menu items in foreign languages, particularly those reading right to left, such as Hebrew and Arabic, since it is language and reading direction independent and thus does not impose reading direction dependent overheads on information transmission bandwidth.

In accordance with a preferred embodiment of the present invention, the free-text space reserved for special requests 1044 is preferably transmitted without compression in the SMS message, as shown at reference numeral 1068.

When operating in a foreign language, specifically a language that uses non-Latin letters, a 1 to 1, letter to letter, encoding table is preferably employed, so as to enable the SMS message to be transmitted in Latin characters, thereby avoiding SMS overheads associated with non-Latin characters. The foreign language that uses non-Latin letters may be a language read from left to right, such as Russian, or a language read from right to left, such as Hebrew and Arabic.

A typical such table appears hereinabove as Table 1.

The SMS messages 1060 also preferably include the customer's delivery instructions and transactional information. This data may be encoded as described hereinabove, in whole or in part, sent in a free-text form, or transmitted in any other suitable manner. The customer's delivery instructions and transactional information may also be stored in the point-of-sale terminal 1058 or otherwise in a restaurant accessible manner, so as not to have to be transmitted with the SMS order.

In accordance with a preferred embodiment of the invention, the point-of-sale terminal 1058 is operative to print out or otherwise display the contents of the SMS message 1060 in a human-readable form. Optionally, the transactional information may not be printed with the order and may be automatically processed in a paperless manner via the point-of-sale terminal 1058 or in any other suitable conventional manner.

In accordance with a preferred embodiment of the present invention, prior to printing out the contents of the SMS message 1060 a human sensible “order waiting” indication is actuated by the SMS message 1060 such as by illuminating a light 1070 on the point-of-sale terminal or providing an audio indication 1072. Only when a human operator presses an “order receipt acknowledged” button 1074, which may be a conventional “Enter” button or on another suitably designated menu location on the point-of-sale terminal 1058, is the print or display provided. This functionality ensures that a positive acknowledgement of order receipt is provided. This acknowledgement is preferably communicated via an SMS message to server 1052 and may also be communicated to the customer via the customer's cellular telephone either as an SMS message or as a voice message and is displayed on the telephone display, as designated by reference number 1076.

Reference is now made to FIG. 1C, which is a simplified pictorial illustration of another preferred embodiment of the present invention employed in a merchandise sales environment, such as an out-of-print book locator network. As seen in FIG. 1C, customers who are trying to find out-of-print books may employ various methods of accessing the locator network, such as accessing an out-of-print book locator site 1200 using a PC based browser 1202. A typical customer indicates the particulars of the book that he wishes to order and is invited to add special requests regarding the selected items, such as “HANDLE WITH CARE”; delivery instructions, such as address, delivery date and telephone contact number and transactional information, such as a credit card number. A typical product order screen, including selected items 1242, special requests 1244, delivery instructions 1246 and transactional information 1248, is designated by reference numeral 1250.

A server 1252, on which the site is located, may be operative to store, based on previously entered information, a customer profile, typically including delivery instructions, such as a delivery address, and conventional transactional information, such as credit card information.

The server 1252 preferably processes the information relating to the customer's order and communicates it as a data stream, using a conventional always-on-line connection such as a Virtual Private Network connection employing an ADSL or CDPD protocol which handles data streams which are not limited in their length. The server 1252 communicates information relating to the customer's order via the Virtual Private Network to a point-of-sale terminal 1258, typically located at a retail bookseller location.

The point-of-sale terminal is preferably a stand-alone point-of-sale terminal, such as an Elite 790 Model manufactured by Ingenico, located at 9 quai De Dion Bouton, 92816, Puteaux Cedex, France or a Nurit 3020 Model manufactured by Lipman Electronic Engineering Ltd. located at Park Afek Industrial Area, Rosh-Haayin, Israel, and may be located in a place of business which may not have an Internet enabled computer.

It is a particular feature of the present invention that a point-of-sale terminal, and particularly a stand-alone point-of-sale terminal, is employed as an order receiving and confirming device.

In accordance with a preferred embodiment of the invention, the point-of-sale terminal 1258 is operative to print out or otherwise display the contents of the message in a human-readable form. Optionally, the transactional information may not be printed with the order and may be automatically processed in a paperless manner via the point-of-sale terminal 1258 or in any other suitable conventional manner.

In accordance with a preferred embodiment of the present invention, prior to printing out the contents of the order message, a human sensible “order waiting” indication is actuated by the order message, such as by illuminating a light 1270 on the point-of-sale terminal or providing an audio indication 1272. Only when a human operator presses an “order receipt acknowledged” button 1274, which may be a conventional “Enter” button or on another suitably designated menu location on the point-of-sale terminal 1258, is the print or display provided. This functionality ensures that a positive acknowledgement of order receipt is provided via server 1252 and the Virtual Private Network to the customer, and is displayed on a computer screen, as designated by reference number 1276.

Reference is now made to FIG. 1D, which is a simplified pictorial illustration of another preferred embodiment of the present invention employed in a customer service environment, such as a hairdressing salon. As seen in FIG. 1D, customers may wish to schedule an appointment at a hairdressing salon.

In accordance with a preferred embodiment of the present invention a customer employs a cellular telephone 1300 to place a telephone call to a call center 1304, such as a manned call center or an IVR computer-based call center. The customer indicates the time of appointment she wishes to schedule: and preferred hairdressing salon. Following the customer's request, the customer is invited to add special requests regarding the scheduled appointment, such as “HAIR COLORING”, customer information, such as address and telephone contact number, and transactional information, such as a credit card number. A typical computer screen at the call center, including information regarding the appointment 1342, special requests 1344, customer information 1346 and transactional information 1348, is designated by reference numeral 1350.

The call center operator, human or computer, preferably accesses customer service request software on a server 1352, which may be the same server as server 1252 in the embodiment of FIG. 1C.

Server 1352, on which the customer service request software is located, may be operative to store, based on previously entered information, a customer profile, typically including information regarding the customer, such as customers address and telephone number, and conventional transactional information, such as credit card information.

The server 1352 preferably processes the information relating to the customer's order and communicates it as a data stream, using a conventional always-on-line connection such as a Virtual Private Network connection employing an ADSL or CDPD protocol which handles data streams which are not limited in their length. The server 1352 communicates information relating to the customer's order via the Virtual Private Network to a point-of-sale terminal 1358, typically located at a customer service location.

The point-of-sale terminal is preferably a stand-alone point-of-sale terminal, such as an Elite 790 Model manufactured by Ingenico, located at 9 quai De Dion Bouton, 92816, Puteaux Cedex, France or a Nurit 3020 Model manufactured by Lipman Electronic Engineering Ltd. located at Park Afek Industrial Area, Rosh-Haayin, Israel, and may be located in a place of business which may not have an Internet enabled computer.

It is a particular feature of the present invention that a point-of-sale terminal, and particularly a stand-alone point-of-sale terminal, is employed as a service request receiving and confirming device.

In accordance with a preferred embodiment of the invention; the point-of-sale terminal 1358 is operative to print out or otherwise display the contents of the message in a human-readable form. Optionally, the transactional information may not be printed with the service request and may be automatically processed in a paperless manner via the point-of-sale terminal 1358 or in any other suitable conventional manner.

In accordance with a preferred embodiment of the present invention, prior to printing out the contents of the order message, a human sensible “order waiting” indication is actuated by the order message, such as by illuminating a light 1370 on the point-of-sale terminal or providing an audio indication 1372. Only when a human operator presses a “request receipt acknowledged” button 1374, which may be a conventional “Enter” button or on another suitably designated menu location on the point-of-sale terminal 1358, is the print or display provided. This functionality ensures that a positive acknowledgement of order receipt is provided. This acknowledgement is preferably communicated via the Virtual Private Network to server 1352 and via the mobile network to the customer at the customer's cellular telephone 1300, such as in the form of an SMS or voice message and is displayed on the telephone display, as designated by reference number 1376.

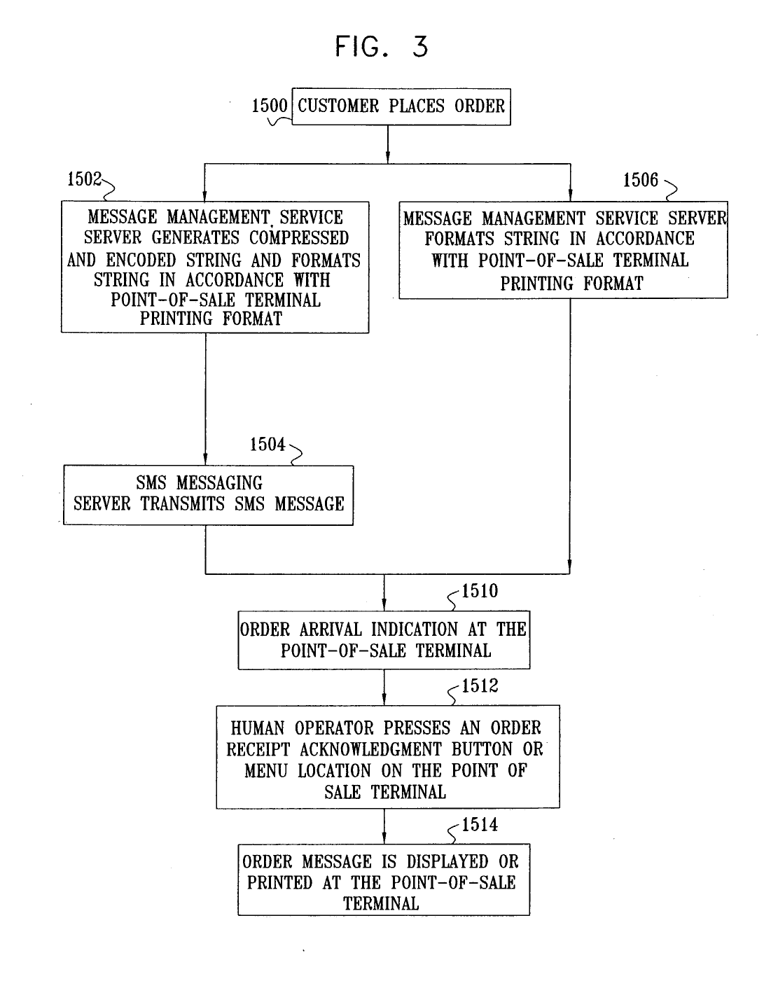

Reference is now made to FIG. 3, which is a simplified flow chart illustrating the general operation of the system and functionality of the embodiments of FIGS. 1A-1D. As illustrated in FIG. 3, a customer employs a computer or a telephone to communicate with an automated or staffed service center in order to place an order, as indicated at 1500.

In accordance with one embodiment of the present invention, as indicated at reference number 1502, a message management service server, such as server 1014 in the embodiment of FIG. 1A, forming part of the service center or controlled thereby, generates an order containing message, preferably in a compressed form suitable for transmission in one or more SMS messages.

As noted above with reference to FIG. 1A, a preferred type of compression, which is particularly suitable for use in conventional SMS messaging, employs a base 70 Latin character alphanumeric code of the type conventional in SMS messages. In the illustrated embodiment, the SMS message appears as a series of numbers and letters, each of which represents a, click selectable menu item. In accordance with a preferred embodiment of the present invention, there are sections of the message that are preferably transmitted without compression, such as the free-text space reserved for special requests 1004 in the SMS message 1022 in the embodiment of FIG. 1A. When operating in a foreign language, specifically a language that uses non-Latin letters, a 1 to 1, letter to letter, encoding table is preferably employed, so as to enable the SMS message to be transmitted in Latin characters, thereby avoiding SMS overheads associated with non-Latin characters. The foreign language that uses non-Latin letters may be a language read from left to right, such as Russian, or a language read from right to left, such as Hebrew and Arabic.

As the message management service server compresses and encodes the message, the message is formatted in accordance with the printing format of a point-of-sale terminal, such as point-of-sale terminal 1020 in the embodiment of FIG. 1A. As indicated at reference number 1504, the message management service server preferably transmits the message using an HTTP in the form of a string via the Internet to an SMS messaging server, such as server 1016 in the embodiment of FIG. 1A. The SMS messaging server transmits the SMS message via a cellular network to a point-of-sale terminal, such as point-of-sale terminal 1020 in the embodiment of FIG. 1A. The message management server and the SMS messaging server may be embodied in a single server.

In accordance with another embodiment of the present invention, as indicated at reference number 1506, a message management service server such as server 1252 in the embodiment of FIG. 1C, forming part of the service center or controlled thereby, generates an order containing message in the form of a data stream and formats the message in accordance with the printing format of a point-of-sale terminal, such as point-of-sale terminal 1258 in the embodiment of FIG; 1C. The message management server preferably transmits the data stream via a Virtual Private Network to a point-of-sale terminal, such as point-of-sale terminal 1258 in the embodiment of FIG. 1C.

As indicated at reference number 1510, when an order bearing message in the form of a data stream or an SMS message arrives at the point-of-sale terminal, preferably a human sensible order arrival notification is provided, such as by illuminating a light 1030 on the point-of-sale terminal or providing an audio indication 1031 in the embodiment of FIG. 1A.

When a human operator of the point-of-sale terminal enters an order receipt acknowledgement, as indicated at reference number 1512, the order is printed or otherwise displayed by the point-of-sale terminal, as indicated at reference number 1514.

It is appreciated that in an embodiment of the present invention the above-described functionality may be employed to place a service request, such as a request to schedule an appointment at a hairdressing salon, as illustrated in the embodiment of FIG. 1D.

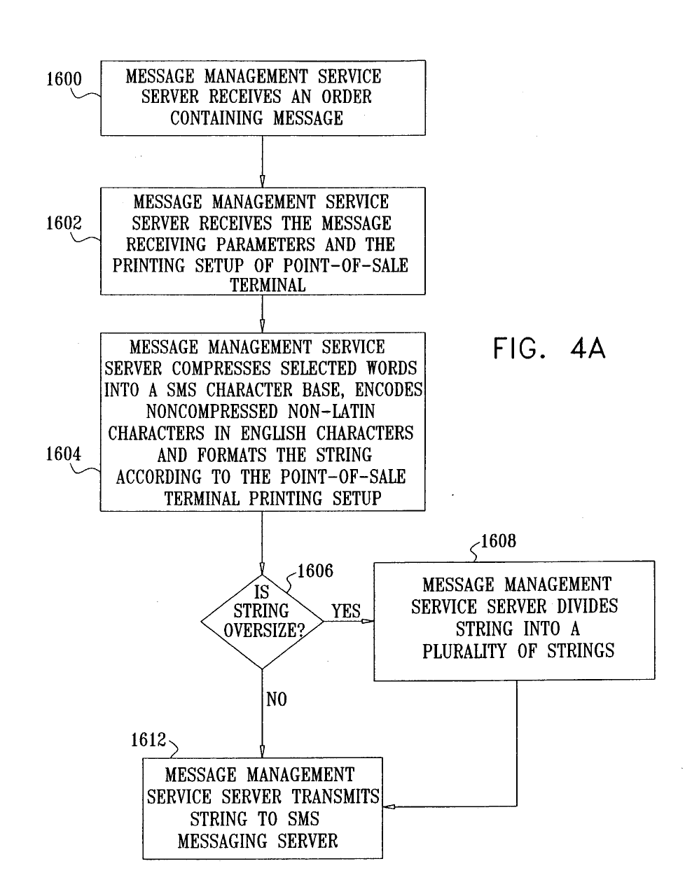

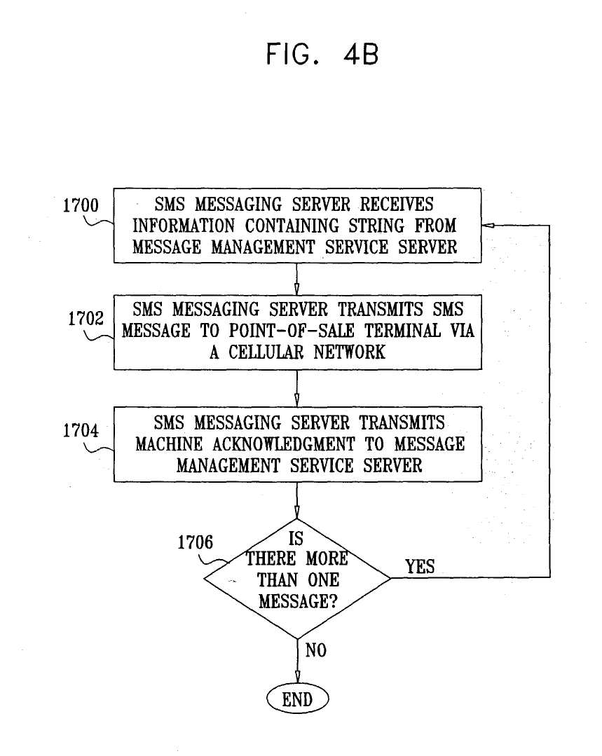

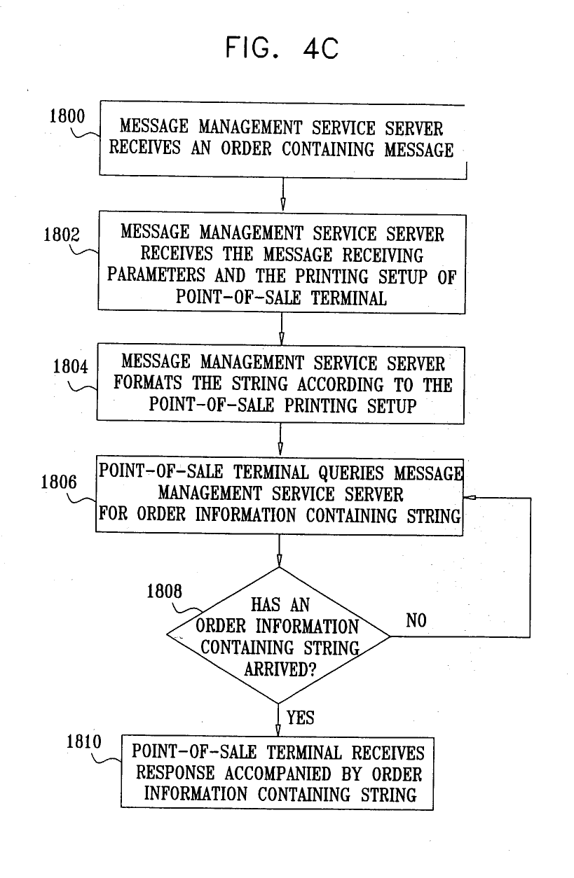

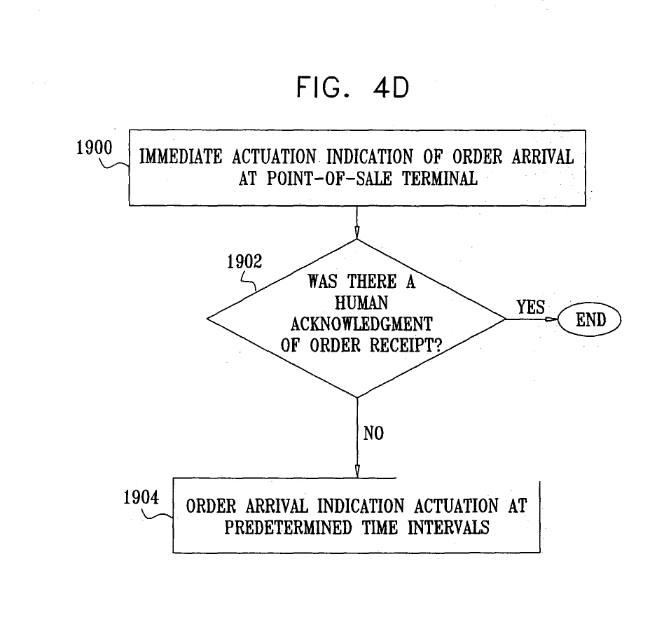

Reference is now made to FIG. 4A, which is a simplified flowchart illustrating the functionality of block 1502 in FIG. 3. As illustrated in FIG. 4A, a message management service server, such as server 1014 in the embodiment of FIG. 1A, receives an order containing message via the Internet, as indicated at reference number 1600. As indicated at reference number 1602, the message management service server receives the message receiving parameters and the printing setup of the point-of-sale terminal to which the message will be transmitted, such as point-of-sale terminal 1020 in the embodiment of FIG. 1A.

The message management service server generates a string, which contains the order information in a compressed and encoded form, as indicated at reference number 1604. The server preferably compresses selected conventional character based words, such as the menu item descriptors 1002 in the embodiment of FIG. 1A. As noted above with reference to FIG. 1A, a preferred type of compression, which is particularly suitable for use in conventional SMS messaging, employs a base 70 Latin character alphanumeric code of the type conventional in SMS messages. In accordance with a preferred embodiment of the present invention, there are sections of the information containing string that are uncompressed, such as the free-text space reserved for special requests 1004 in the embodiment of FIG. 1A. When operating in a foreign language, such as that reading right to left, such as Hebrew and Arabic, a 1 to 1, letter to letter encoding table, such as Table 1 shown hereinabove, is followed, so as to enable an SMS message to be transmitted in English, thereby avoiding SMS overheads associated with non-Latin characters.

The information containing string is formatted in accordance with the printing format of a point-of-sale terminal, such as point-of-sale terminal 1020 in the embodiment of FIG. 1A. If the string exceeds a maximum SMS message length allowed, the information containing string is divided into a plurality of information containing strings, as indicated at reference numbers 1606 and 1608.

As indicated at reference number 1612, the message management service server preferably transmits the information containing string using an HTTP protocol via the Internet to an SMS messaging server, such as server 1016 in the embodiment of FIG. 1A.

Reference is now made to FIG. 4B, which is a simplified flowchart illustrating the functionality of block 1504 in FIG. 3. As illustrated in FIG. 4B, an SMS messaging server, such as server 1016 in the embodiment of FIG. 1A, receives an order information containing string from the message management service server, such as server 1014 in the embodiment of FIG. 1A, as indicated at reference number 1700. As indicated at reference number 1702, the SMS messaging server transmits the order information as an SMS message, such as SMS message 1022 in the embodiment of FIG. 1A, to a point-of-sale terminal, such as point-of-sale terminal 1020 in the embodiment of FIG. 1A, via a cellular network.

As indicated at reference number 1704, upon the arrival of the SMS message at the point-of-sale terminal the SMS messaging server transmits to the message management service server a machine acknowledgment that the SMS message has arrived at the point-of-sale terminal. As indicated at reference number 1706, if a plurality of SMS messages are transmitted, the above steps are repeated and the SMS messages are combined at the point-of-sale terminal in order to form a single order.

Reference is now made to FIG. 4C, which is a simplified flowchart illustrating the functionality of block 1506 in FIG. 3. As illustrated in FIG. 4C, a message management service server, such as server 1252 in the embodiment of FIG. 1C, receives an order containing message in the form of a string via the Internet, as indicated at reference number 1800. As indicated at reference number 1802, the message management service server receives the message receiving parameters and the printing setup of the point-of-sale terminal to which the message will be transmitted, such as point-of-sale terminal 1258 in the embodiment of FIG. 1C.

The message management service server formats the information containing string in accordance with the printing format of the point-of-sale terminal, as indicated at reference number 1804. The point-of-sale terminal preferably queries the message management service server for an information containing string at predetermined time intervals and receives a positive response, as indicated at reference numbers 1806, 1808 and 1810. Once an order has arrived at the message management service server, the point-of-sale terminal may query the message management service server at time intervals shorter than the predetermined time intervals.

The positive response from the message management service server is preferably accompanied by the order information containing string in the form of a data stream, via a conventional always-on-line connection such as a Virtual Private Network connection employing an ADSL or CDPD protocol which handles data streams which are not limited in their length.

It is appreciated that the query methodology is employed in order not to interfere with other information stored in the point-of-sale terminal, such as credit card information.

Alternatively, the transmission of the string may be initiated by the message management service server or the message management service server may signal the point-of-sale terminal to request an information containing string.

Reference is now made to FIG. 4D, which is a simplified flowchart illustrating the functionality of block 1510 in FIG. 3. As illustrated in FIG. 4D, when an order bearing message in the form of an SMS message, such as SMS message 1022 in the embodiment of FIG. 1A, or a data stream as in the embodiment of FIG. 1C, arrives at a point-of-sale terminal, such as point-of-sale terminal 1020 in the embodiment of FIG. 1A, a human sensible “order waiting” indication is immediately actuated.

The human sensible “order waiting” indication may be actuated by illuminating a light 1030 on the point-of-sale terminal or providing an audio indication 1031 in the embodiment of FIG. 1A, as indicated at reference number 1900. If a human acknowledgment of order receipt is not provided, the “order waiting” indication is actuated at predetermined time intervals until a human acknowledgment is provided, as indicated at reference numbers 1902 and 1904.

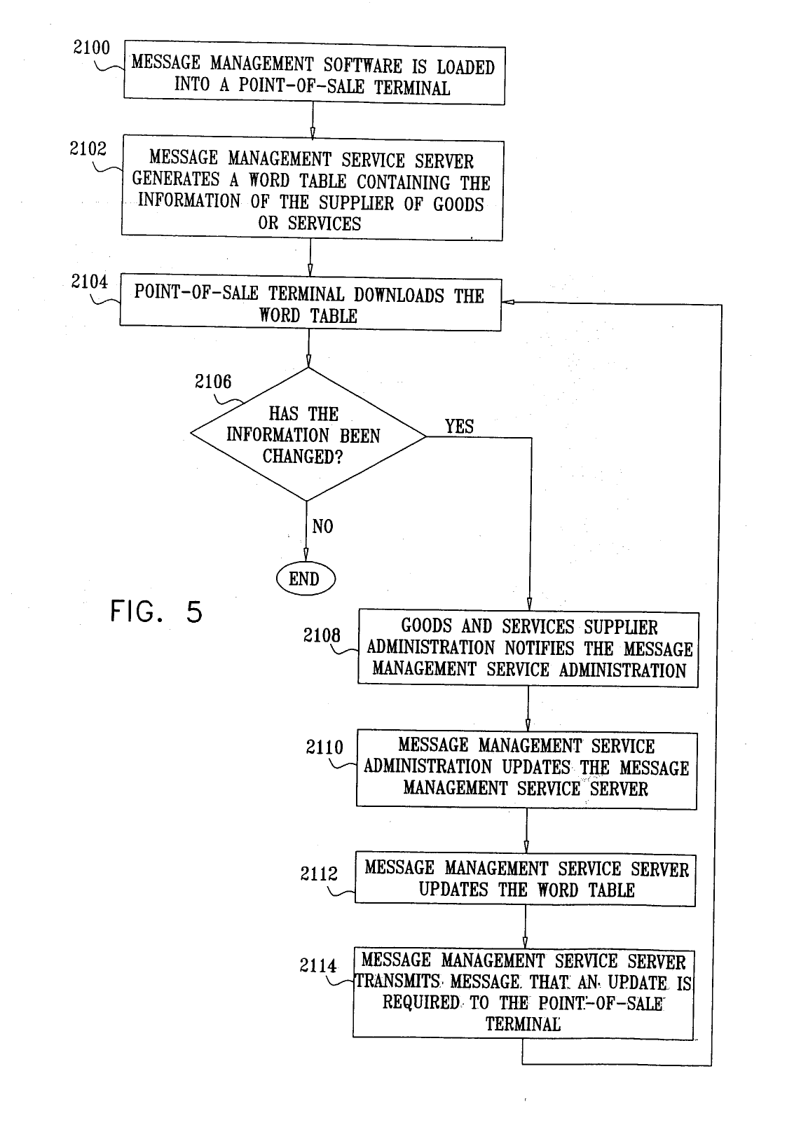

Reference is now made to FIG. 5, which illustrates the general operation of the functionality employed in FIGS. 1A-1D. As illustrated in FIG. 5, message management software is loaded into a point-of-sale terminal, such as point-of-sale terminal 1020 in the embodiment of FIG. 1A, located at the premises of a supplier of goods or services, as indicated at reference number 2100. A message management service server, such as server 1014 in the embodiment of FIG. 1A, generates a word table containing order terms used by the supplier of goods or services, such as a list of menu item descriptors, as indicated at reference number 2102.

The point-of-sale terminal downloads the word table, as indicated at reference number 2104. If the supplier of goods or services has updated the information contained in the word table, the supplier of goods or services notifies a message management service administration, which updates the information stored at the message management server, as indicated at reference numbers 2106, 2108 and 2110. The message management server, in turn, updates the word table, as indicated at reference number 2112.

The message management server transmits a message to the point-of-sale terminal that an update is required, as indicated at reference number 2114. The point-of-sale terminal, in turn, downloads the updated word table.

Reference is now made to Appendix 1, which is a computer listing which forms a preferred software embodiment of the present invention, suitable for use in the embodiments of FIGS. 1A-1D.

The CD-ROM appendix attached herewith is a computer listing of a preferred software implementation of an orders management and transporting system constructed and operative in accordance with the preferred embodiments of the present invention. Appendix 1 includes executable code installed in a message management service server, such as server 1014 of FIG. 1A, and a point-of-sale terminal, such as point-of-sale terminal 1020 of FIG. 1A, enabling them to carry out the functionality described hereinabove with reference to FIGS. 1A-1D.

In the installation procedure described hereinbelow, a message management service server, such as server 1014 of FIG. 1A, is embodied in an Intel compatible computer, referenced in step 1 hereinbelow, and a point-of-sale terminal, such as point-of-sale terminal 1020 of FIG. 1A, is embodied in an INGENICO credit card terminal model #790, referenced in step 5.6 hereinbelow. A preferred method for installing and running the software listing of the CD-ROM appendix is as follows:

1. Provide an Intel compatible computer with a minimum of 128 MB RAM and a Pentium III central processing unit with connectivity to the Internet and install the following:

1.1. Microsoft Windows 2000 Server or higher version, running Service Pack 3;

1.2. Borland C\C++ Compiler, version 5.0 or higher version;

1.3. Ingedev environment version 2.3, by INGENICO;

1.4. Microsoft ActiveX Data Objects 2.7 Library;

1.5. Microsoft Visual Basic 6 SP5 with Service Pack 5;

1.6. Microsoft SQL Server 2000 Standard Edition with Service Pack 3;

1.7. Microsoft Internet Information Services 5;

1.8. Microsoft XML Parser 2.0;

1.9. Cellact CASMSender;

2. Copy the file CARDCLIENT.HEX in the root folder stored in the appended CD-ROM into a temporary directory.

3. Unhex the computer listing CARDCLIENT.HEX mentioned in step 2 using HEX IT V1.8 or greater by John Augustine, 3129 Earl St., Laureldale, Pa. 19605 creating file CARDCLIENT.ZIP

4. Decompress the file CARDCLIENT.ZIP created in step 3 using WINZIP version 6.2 or greater, extracting all files into a temporary directory using the option ‘use folder names’.

5. Client Installation/Run:

5.1. Run Ingedev from Start->Programs->Ingedev

5.2. Select Project\Open and browse to the Ingedev-Project-File CardClient.mki located in the temporary directory designated in step 4.

5.3. Select Options\Directories from the menu and verify the following:

5.3.1. Compiler Path: C51P\BIN; c:\bc5\BIN

5.3.2. Include Files Path: inc; c:\INGEDEV\SIMELITE\MINC; C51P\INC; simul; c:\INGEDEV\sim_fr\minc

5.3.3. Library Files Path: 51keil; C51P\LIB; c:\Ingedev\Simelite\M1lib\51keil;

5.3.4. Object Files Path: OBJ\

5.3.5. Release Files Path: RES\

5.3.6. Download Slave Path: c:\INGEDEV\DOWNLOAD\Slave\

5.3.7. Download Alone Path: c:\INGEDEV\DOWNLOAD\Alone\

5.4. Select Target\Build All and compile the project

5.5. Select Tools\Download the application

5.6. Connect an RS232 cable to an INGENICO credit card terminal model #790 and enter the download mode at the INGENICO credit card terminal model #790 by pressing ‘Cancel’ as soon as the INGENICO credit card terminal model #790 boots. Enter the download password from Ingedev's download dialog prompt and press ‘Enter’. The application is now downloaded into the INGENICO credit card terminal model #790 awaiting input from the server application.

6. Server Installation/run

6.1. Copy the file Go4EatCC.HEX and DBBackup.HEX in the root folder stored in the appended CD-ROM into a temporary directory.

6.2. Unhex the computer listing Go4EatCC.HEX mentioned in step 6.1 using HEX IT V1.8 or greater by John Augustine, 3129 Earl St., Laureldale, Pa. 19605 creating file Go4EatCC.DLL within the folder c:\server

6.3. Unhex the computer listing DBBackup.HEX mentioned in step 6.1 using HEX IT V1.8 or greater by John Augustine, 3129 Earl St., Laureldale, Pa. 19605 creating file DBBackup within the folder c:\server\backup

6.4. Go to Start->Run . . . and run the command: RegSvr32 c:\Server\Go4EatCC.dll

6.5. Import the SQL Server database Go4Eat to the computer's SQL Server, using the supplied backup file c:\server\backup\DBBackup.

6.6. Define a user named “user”. Grant this user a System Administrators server role and set his default database to “Go4Eat”.

6.7. Web site creation

6.7.1. Copy the file ASPfiles.HEX in the root folder stored in the appended CD-ROM into a temporary directory.

6.7.2. Unhex the computer listing ASPfiles.HEX mentioned in step 6.7.1 using HEX IT V1.8 or greater by John Augustine, 3129 Earl St., Laureldale, Pa. 19605 creating file ASPfiles.ZIP.

6.7.3. Decompress the file ASPfiles.ZIP created in step 6.7.2 using WINZIP version 6.2 or greater, extracting all files into a temporary directory.

6.7.4. Create a folder in the computer's hard-drive named “C:\Go4EatWeb”.

6.7.5. Under that folder create 2 folders: “\secure” and “\cgi-bin”.

6.7.6. Copy the file “cellact.asp” and “confirmation.asp” from the temporary directory created in step 6.7.3 to the “secure” folder.

6.7.7. Copy the files: “adoobjects.inc”, “adovbs.inc”, “sub.inc”, and “variables.inc” from the temporary directory created in step 6.7.3 to the “\cgi-bin” folder.

6.7.8. Create a web site in IIS (Internet Information Services), name it “Go4Eat” and make its root folder point to “C:\Go4EatWeb”.

6.8. Copy the file TaskAgentSTC.HEX in the root folder stored in the appended CD-ROM into a temporary directory.

6.9. Unhex the computer listing TaskAgentSTC.HEX mentioned in step 6.8 using HEX IT V1.8 or greater by John Augustine, 3129 Earl St., Laureldale, Pa. 19605 creating file TaskAgentSTC.ZIP

6.10. Decompress the file TaskAgentSTC.ZIP created in step 6.9 using WINZIP version 6.2 or greater, extracting all files into a temporary directory using the option ‘use folder names’.

6.11. Run Microsoft Visual Basic, and then open the project “TaskAgent.vbp” from the temporary folder created in step 6.10.

6.12. Go to Project->References and make sure these components are checked:

Microsoft ActiveX Data Objects 2.7 Library

Cellact CASMSSender

6.13. Press F5 to run the program

List of commercial vendors cited as prerequisites for installation:

Borland Software Corporation

100 Enterprise Way

Scotts Valley, Calif. 95066-3249 U.S.A.

Tel: 831-431-1000

Cellact Ltd

P.O. Box 286

Shefayim 60990, Israel

Phone: +972 9 970 4110

INGENICO

9, Quai de Dion Bouton

92816 Puteaux Cedex-France.

Tel: 33 (0) 1 46 25 82 00

Microsoft Corporation

One Microsoft Way

Redmond, Wash. 98052 U.S.A.

Phone: (425) 882-8080

It is appreciated that the particular embodiment implemented by the appendix is intended only to provide an extremely detailed disclosure of the present invention and is not intended to be limiting.

It will be appreciated by persons skilled in the art that the present invention is not limited by what has been particularly shown and described herein above. Rather the scope of the present invention includes both combinations and subcombinations of the various features described hereinabove as well as variations and modifications which would occur to persons skilled in the art upon reading the specifications and which are not in the prior art.

1. A message communications system comprising:
a plurality of point-of-sale terminals including human sensible message receiving functionality and human sensible message delivering functionality; and
a communications network communicating with said plurality of point-of-sale terminals and transmitting thereto human sensible messages.

2. A message communications system according to claim 1 and wherein said plurality of point-of-sale terminals each comprise a dedicated point-of-sale communications processor operating software embodying said human sensible message receiving functionality and said human sensible message delivering functionality.

3. A message communications system according to claim 1 and wherein said human sensible message is received via an SMS message.

4. A message communications system according to claim 1 and wherein said human sensible message is received via a data stream.

5. A message communications system according to claim 4 and wherein said data stream is a multiple protocol compatible data stream.

6. A message communications system according to claim 1 and wherein said human sensible message is received via a data packet.

7. A message communications system according to claim 4 and wherein said data stream is a multiple protocol compatible data packet.

8. A message communications system according to claim 1 and wherein said human sensible message contains a commercial order.

9. A message communications system according to claim 1 and wherein said communications network comprises a telephone network.

10. A message communications system according to claim 9 and wherein said telephone network comprises an IVR, which receives a DTMF, input and provides a voice response.

11. A message communications system according to claim 1 and wherein said communications network comprises a computer communications network.

12. A message communications system according to claim 1 and wherein said communications network comprises an at least partially Internet based computer communications network.

13. A message communications system according to claim 1 and wherein said plurality of point-of-sale terminals each comprise dedicated point-of-sale software operating in cooperation with software embodying said human sensible message receiving functionality and said human sensible message delivering functionality.

14. A message communications system according to claim 1 and wherein at least one of said plurality of terminals and said communications network have a mandatory human actuated acknowledgement functionality operative to prevent human sensible message delivery prior to provision of a human actuated acknowledgement of receipt of said human sensible message.

15. A message communications system according to claim 1 and wherein said plurality of terminals include e-mail receiving functionality and mandatory human actuated acknowledgement functionality operative to prevent printing or display of a received e-mail prior to human actuated acknowledgement of receipt thereof.

16. A message communications system according to claim 1 and wherein said plurality of terminals includes facsimile receiving functionality and mandatory human actuated acknowledgement functionality operative to prevent printing of a received facsimile prior to human actuated acknowledgement of receipt thereof.

17. A message communications system according to claim 1 and wherein said plurality of terminals includes file transfer receiving functionality and mandatory human actuated acknowledgement functionality operative to prevent opening, printing, saving or display of a received file prior to human actuated acknowledgement of receipt thereof.

18. A message communications system according to claim 14 and wherein said mandatory human actuated acknowledgement functionality includes human acknowledger identification functionality, which identifies a human actuating said acknowledgement.

19. A message communications system according to claim 1 and wherein:
said human sensible message receiving functionality comprises text message receiving functionality;
said human sensible message delivering functionality comprises text message delivering functionality;
said human sensible messages comprise text messages; and
said communications network has a compression functionality operative to code said text messages, and employing a base 70 Latin character alphanumeric code of the type used in SMS messages.

20. A message communications system according to claim 19 and wherein said compression functionality is operative to code a predetermined finite vocabulary.

21. A message communications system according to claim 19 and wherein said text message receiving functionality comprises an SMS functionality.

22. A message communications system according to claim 1 and wherein:
said human sensible message receiving functionality comprises text message receiving functionality;
said human sensible message delivering functionality comprises text message delivering functionality;
said human sensible messages comprise text messages; and
said communications network has a language conversion functionality operative to convert text messages in non-Latin letters to a base 70 Latin character alphanumeric code of the type used in SMS messages.

23. A message communications system comprising:
a plurality of terminals including human sensible message receiving functionality and human sensible message delivering functionality; and
a communications network communicating with said plurality of terminals and transmitting thereto human sensible messages,
at least one of said plurality of terminals and said communications network having a mandatory human actuated acknowledgement functionality operative to prevent human sensible message delivery prior to provision of a human actuated acknowledgement of receipt of said human sensible message.

24. A message communications system according to claim 23 and wherein said plurality of terminals includes facsimile receiving functionality and said mandatory human actuated acknowledgement functionality is operative to prevent printing of a received facsimile prior to human actuated acknowledgement of receipt thereof.

25. A message communications system comprising:
a plurality of terminals including text message receiving functionality and text message delivering functionality; and
a communications network communicating with said plurality of terminals and transmitting thereto text messages,
said communications network having a compression functionality operative to code said text messages, and employing a base 70 Latin character alphanumeric code of the type used in SMS messages.

26. A message communications system according to claim 25 and wherein said compression functionality is operative to code a predetermined finite vocabulary.

27. A message communications system according to claim 25 and wherein said text message receiving functionality comprises an SMS functionality.

28. A message communications system according to claim 25 and wherein said text message contains a commercial order.

29. A message communications system comprising:
a plurality of terminals including text message receiving functionality and text message delivering functionality; and
a communications network communicating with said plurality of terminals and transmitting thereto text messages,
said communications network having a language conversion functionality operative to convert text messages in non-Latin letters to a base 70 Latin character alphanumeric code of the type used in SMS messages.

30. A message communications system according to claim 29 and wherein said text message contains a commercial order.

31. A message communication method comprising:
providing a communications network and a plurality of point-of-sale terminals including human sensible message receiving functionality and human sensible message delivering functionality;
communicating between said communications network and said plurality of point-of-sale terminals; and
transmitting human sensible messages to said plurality of point-of-sale terminals.

32. A message communications method according to claim 31 and also comprising operating software embodying said human sensible message receiving functionality and said human sensible message delivering functionality.

33. A message communications method according to claim 31 and also comprising receiving said human sensible message via an SMS message.

34. A message communications method according to claim 31 and also comprising receiving said human sensible message via a data stream.

35. A message communications method according to claim 34 and wherein said receiving said human sensible message via said data stream comprises receiving said human sensible message via a multiple protocol compatible data stream.

36. A message communications method according to claim 31 and also comprising receiving said human sensible message via a data packet.

37. A message communications method according to claim 34 and wherein said receiving said human sensible message via said data stream comprises receiving said human sensible message via a multiple protocol compatible data packet.

38. A message communications method according to claim 31 and wherein said transmitting human sensible messages comprises transmitting commercial orders.

39. A message communications method according to claim 31 and wherein said communications network comprises a telephone network.

40. A message communications method according to claim 39 and also comprising:
receiving a DTMF input; and
providing a voice response.

41. A message communications method according to claim 31 and wherein said communications network comprises a computer communications network.

42. A message communications method according to claim 31 and wherein said communications network comprises an at least partially Internet based computer communications network.

43. A message communications method according to claim 31 and also comprising operating dedicated point-of-sale software in cooperation with software embodying said human sensible message receiving functionality and said human sensible message delivering functionality.

44. A message communications method according to claim 31 and also comprising:
acknowledging, via a mandatory human actuated acknowledgement functionality, receipt of said human sensible message;
preventing delivery of said human sensible message until completion of said acknowledging; and
delivering said human sensible message, subsequent to said acknowledging.

45. A message communications method according to claim 44 and wherein said transmitting human sensible messages comprises transmitting e-mail messages and said preventing delivery comprises preventing printing or display of said e-mail messages.

46. A message communications method according to claim 44 and wherein said transmitting human sensible messages comprises transmitting facsimile messages and said preventing delivery comprises preventing printing of said facsimile messages.

47. A message communications method according to claim 44 and wherein said transmitting human sensible messages comprises transmitting files and said preventing delivery comprises preventing opening, printing, saving or display of said files.

48. A message communications method according to claim 44 and wherein said acknowledging also comprises identifying the human performing said acknowledging.

49. A message communications method according to claim 31 and wherein said transmitting human sensible messages comprises transmitting text messages and the method also comprises compressing said text messages employing a base 70 Latin character alphanumeric code of the type used in SMS messages prior to said transmitting.

50. A message communications method according to claim 49 and wherein said compressing comprises coding a predetermined finite vocabulary.

51. A message communications method according to claim 49 and wherein said human message receiving functionality comprises an SMS functionality.

52. A message communications method according to claim 31 and wherein said transmitting human sensible messages comprises:
converting text messages in non-Latin letters to a base 70 Latin character alphanumeric code of the type used in SMS messages; and
subsequently transmitting said text messages to said plurality of terminals.

53. A message communications method comprising:
providing a communications network and a plurality of terminals including human sensible message receiving functionality and human sensible message delivering functionality;
communicating between said communications network and said plurality of terminals;
transmitting human sensible messages to said plurality of terminals,
acknowledging, via a mandatory human actuated acknowledgement functionality, receipt of said human sensible message;
preventing delivery of said human sensible message until completion of said acknowledging; and
delivering said human sensible message, subsequent to said acknowledging.

54. A message communications method according to claim 53 and wherein said transmitting human sensible messages comprises transmitting facsimile messages and said preventing delivery comprises preventing printing of said facsimile messages.

55. A message communications method comprising:
providing a communications network and a plurality of terminals including text message receiving functionality and text message delivering functionality;
communicating between said communications network and said plurality of terminals;
transmitting text messages to said plurality of terminals; and
compressing said text messages employing a base 70 Latin character alphanumeric code of the type used in SMS messages prior to said transmitting.

56. A message communications method according to claim 55 and wherein said compressing comprises coding a predetermined finite vocabulary.

57. A message communications method according to claim 55 and wherein said text message receiving functionality comprises an SMS functionality.

58. A message communications method according to claim 55 and wherein said transmitting said text message comprises transmitting commercial orders.

59. A message communications method comprising:
providing a communications network and a plurality of terminals including text message receiving functionality and text message delivering functionality;
communicating between said communications network and said plurality of terminals;
converting text messages in non-Latin letters to a base 70 Latin character alphanumeric code of the type used in SMS messages; and
subsequently transmitting said text messages to said plurality of terminals.

60. A message communications method according to claim 59 and wherein said transmitting said text message comprises transmitting commercial orders.
